(19) United States
(12) Patent Application Publication
(10) Pub. No.: US 2007/0294423 A1
(43) Pub. Date: Dec. 20, 2007

(54) Multi-Client Single-Session Media Streaming

(75) Inventors: Allan Brockenbrough, Hamilton, MA (US); Prasad Rallabandi, Westford, MA (US)

Correspondence Address: STAAS & HALSEY LLP, SUITE 700, 1201 NEW YORK AVENUE, N.W., WASHINGTON, DC, 20005, US

(73) Assignee: Comverse, Inc., Wakefield, MA (US)

(21) Appl. No.: 11/424,026

(22) Filed: Jun. 14, 2006

(51) Int. Cl. G06F 15/16

(52) U.S. Cl. 709/231; 709/203

(57) ABSTRACT

Multi-client single-session media streaming is disclosed. One process includes setting up a single logical connection to a media server for a media to be transmitted, and transmitting the media from the media server over the single logical connection to a plurality of clients.

### BACKGROUND OF THE INVENTION

1. Field of the Invention

The present invention relates generally to multi-client single-session media streaming. More particularly, the present invention relates to setting up a single logical connection to a media server for a media to be transmitted, and transmitting the media from the media server over the single logical connection to a plurality of clients.

2. Description of the Related Art

Devices capable of reproducing streaming media (such as live video streams) are popular. An example of such a device is the video handset mobile telephone. A client may use a video handset mobile telephone to view a live video stream, such as a rock concert music performance.

In the case of a networked device, such as a video handset mobile telephone, a client may send a request to a service provider for a particular streaming media item. The service provider may then open a connection to a resource provider providing the requested media item. Thus, the service provider functions as an intermediary. As an example of the process, a client wishing to view a music performance may enter a uniform resource identifier (URI) into their video handset mobile telephone. The service provider, upon receiving the URI, may then open a connection to an RTSP server (or other service provider) providing the rock concert.

Each connection between the resource provider and the service provider is really a single logical connection, as there may actually be several sub-connections between the resource provider and the service provider for each logical connection. For example, an RTSP server connection may include multiple socket connections: an RTSP connection, an RTP audio connection, an RTCP audio connection, an RTP video connection, and an RTCP video connection.

Typically, when multiple clients request the same streaming media item, the service provider opens multiple logical connections (each having the sub-connections) to the resource provider for the same media item. Each one of these logical connections consumes resources of the service provider.

Therefore, there exists a need to provide a streaming media item to multiple clients while reducing the burden on the service provider.

### SUMMARY OF THE INVENTION

It is an aspect of the invention to enable multi-client single-session media streaming.

According to an aspect of the present invention, there is provided a process including setting up a single logical connection to a media server for a media to be transmitted, and transmitting the media from the media server over the single logical connection to a plurality of clients.

According to another aspect of the present invention, there is provided a process including establishing a streaming session for a streaming resource by opening a single set of socket connections to a media server, and providing the streaming resource received via the single set of socket connections to a plurality of mobile telephones.

According to another aspect of the present invention, there is provided a process including tracking a plurality of users requesting a data resource stored on a server, receiving the data resource over a single logical connection to the server, and duplicating the received data resource for the plurality of users requesting the data resource stored on the server.

According to another aspect of the present invention, there is provided an apparatus including a receiver to receive packets over a single set of socket connections for a streaming resource, and a provider to provide the packets received over the single set of socket connections to a plurality of mobile telephones.

According to another aspect of the present invention, there is provided a system including a media server including a streaming resource, a plurality of mobile phones, and a unit to establish a streaming session for the streaming resource by opening a single set of socket connections to the media server and to provide the streaming resource received via the single set of socket connections to the plurality of mobile phones.

According to another aspect of the present invention, there is provided a system including a server including a data resource, a unit to track a plurality of users requesting the data resource, a receiver to receive the data resource over a single logical connection to the server, and a duplicator to duplicate the received data resource for the plurality of users requesting the data resource stored on the server.

According to another aspect of the present invention, there is provided a system including a means for establishing a single logical connection to a server for a media to be transmitted, and a means for transmitting the media from the media server over the single logical connection to a plurality of clients.

According to another aspect of the present invention, there is provided a storage including a data structure. The data structure includes a field comprising a media identifier, a field comprising a session identifier associated with the media identifier, and a field comprising a client identifier associated with the session identifier.

The foregoing and other aspects will become apparent from the following detailed description of the invention when considered in conjunction with the accompanying drawing figures.

### BRIEF DESCRIPTION OF THE DRAWINGS

FIG. 1 is a schematic representation of a multi-client single-session media streaming system in accordance with an embodiment of the present invention.

FIG. 2 is a schematic representation of the session dynamic library and the resource server of FIG. 1, in accordance with an embodiment of the present invention.

FIG. 3 is a schematic representation of the session dynamic library and the resource server of FIGS. 1 and 2, in accordance with an embodiment of the present invention.

FIG. 4 is a schematic representation of a process of streaming media in accordance with an embodiment of the present invention.

FIG. 5 is a schematic representation of a process of streaming media in accordance with an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures. Although the embodiments described below are discussed with reference to particular combinations of software and hardware, alternative combinations of software and hardware are contemplated. For example, features embodied as software conceivably could be embodied as hardware, and vice versa. These alternative combinations are considered to be within the scope of the invention.

The present invention is directed to distributing media received from a media server over a single logical connection to multiple clients.

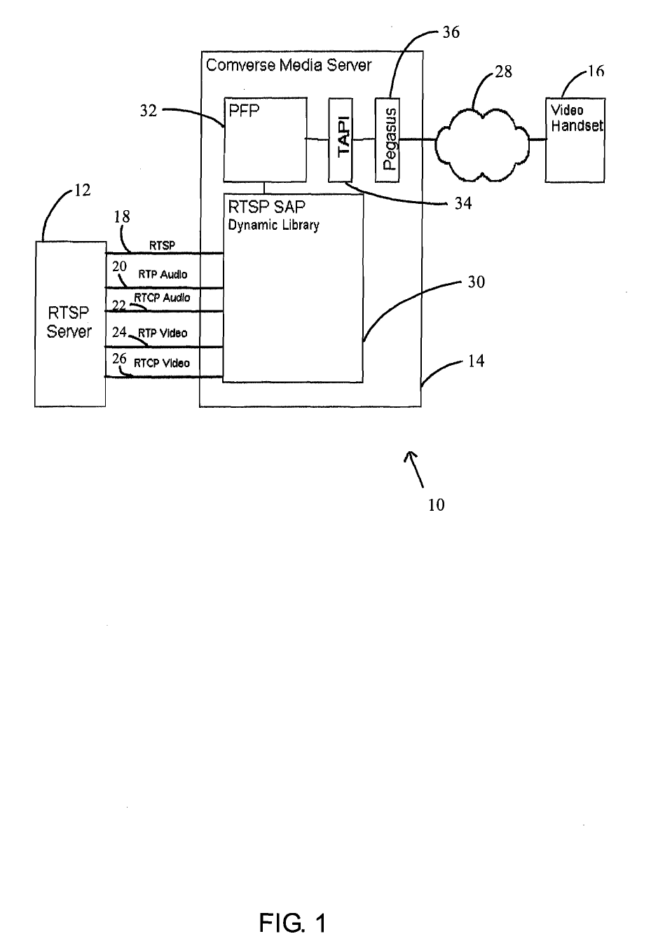

FIG. 1 is a schematic representation of a multi-client single-session media streaming system 10 in accordance with an embodiment of the present invention. The system 10 may include a resource server 12, an intermediary server 14, and a client 16. In an embodiment, the resource server 12 may be embodied as a real time streaming protocol (RTSP) server and the client 16 may be embodied as a video handset mobile telephone. Alternative embodiments including PC-based video applications are contemplated and are considered to be within the scope of the invention.

The resource server 12 may contain one or more streaming resources (or media or data resources). For each streaming resource, the resource server 12 may be in communication with the intermediary server 14 via a single logical connection that may include a number of individual connections. In an embodiment, the single logical connection may include an RTSP connection 18, an RTP audio connection 20, an RTCP audio connection 22, an RTP video connection 24, and an RTCP video connection 26.

The intermediary server 14 may include a session dynamic library 30 as well as further packet processing hardware and software, such as a Platform Process Unit (PFP) 32, a Telephony Application Programming Interface (TAPI), and a time division multiplexing (TDM) or Voice over Internet Protocol (VOIP) board 36. The PFP may hold the state of calls in progress, and, based on the telephony application being processed, may send commands to other components. For example, in the case of a streaming video application, the PFP uses an RTSP SAP to gather video information and the PFP passes this information to the TAPI component. The session dynamic library 30 may establish a session for each single logical connection between the intermediary server 14 and the resource server 12.

The intermediary server 14 may be in communication with the client 16 via a communications network 28. The communications network 28 may include a third-generation, PSTN, Cellular, Cable and/or VoIP network.

A client 16 may send a request to the intermediary server 14 for a streaming resource through the communications network 28. The session dynamic library 30 may provide the streaming resource provided from the resource server 12 to the client 16. If there are multiple clients requesting the same streaming resource, the session dynamic library may cause the duplication of the streaming resource received from the resource server 12 over the single logical connection, and distribution of the duplicated streaming resource to the multiple clients.

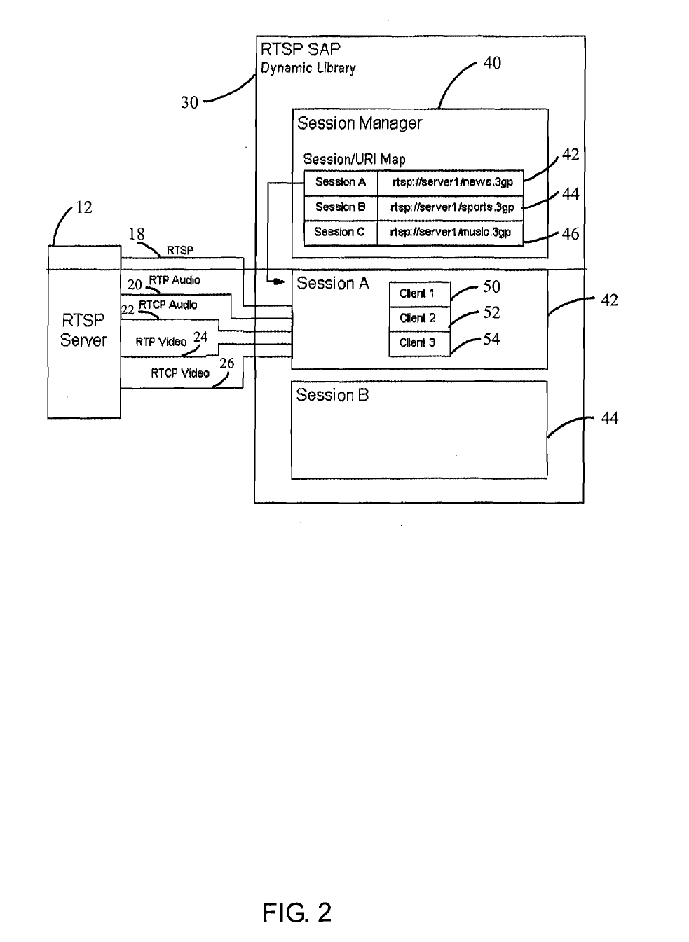

FIG. 2 is a schematic representation of the session dynamic library 30 and the resource server 12 of FIG. 1, in accordance with an embodiment of the present invention.

The session dynamic library 30 may include a session manager 40. The session manager 40 may include information for a session or multiple sessions. As a non-limiting example, the session manager 40 as it is depicted in FIG. 2 includes information for three different sessions: session A 42; session B 44; and session C 46. Sessions A 42, B 44, and C 46, in this example, correspond to news, sports, and music streaming resources, respectively. The information for each session may include a resource address and a list of clients associated with the session (receiving the streaming resource). The resource address may be a uniform resource identifier (URI). In the current non-limiting example, session A 42 includes the resource address rtsp://server1/news.3gp, session B 44 includes the resource address rtsp://server1/sports.3gp, and session C 46 includes the resource address rtsp://server1/music.3gp. The clients associated with session A 42 include client 1 50, client 2 52, and client 3 54. In an embodiment, sessions may be tracked or mapped using a session map.

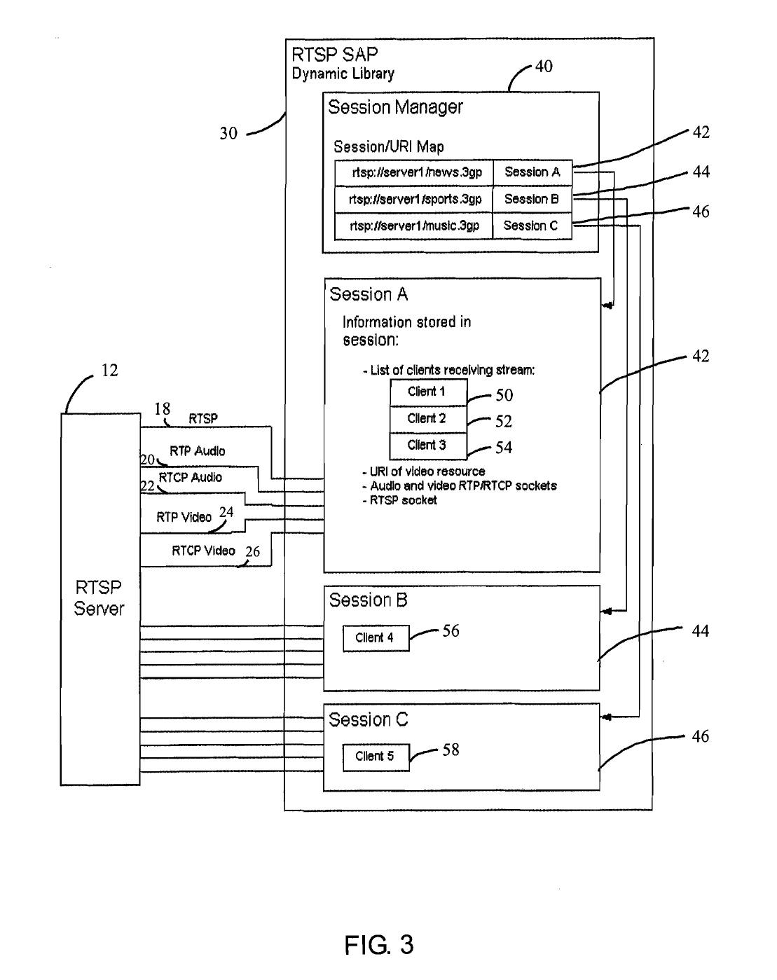

FIG. 3 is a schematic representation of the session dynamic library 30 and the resource server 12 of FIGS. 1 and 2, in accordance with an embodiment of the present invention. As already noted, the session manager 40 may include a resource address and a list of clients associated with the session. In an embodiment, the session manager 40 may also include additional information, such as information regarding an RTSP socket, an RTP audio socket, an RTCP audio socket, an RTP video socket, an RTCP video socket, expected resource length (video and audio), and/or the state of the streaming (starting, playing, etc.).

In the non-limiting example depicted in FIG. 3, session A 42 corresponds to a news resource streaming from the resource server 12 over a single logical connection. The single logical connection includes an RTSP connection 18, an RTP audio connection 20, an RTCP audio connection 22, an RTP video connection 24, and an RTCP video connection 26. Session B 44 corresponds to a sports resource streaming from the resource server 12 over a single logical connection. Session C 46 corresponds to a music resource streaming from the resource server 12 over a single logical connection. Also as depicted in FIG. 3, clients 1 50, 2 52, and 3 54 are associated with session A 42. Client 4 56 is associated with session B 44, and client 5 58 is associated with session C 46.

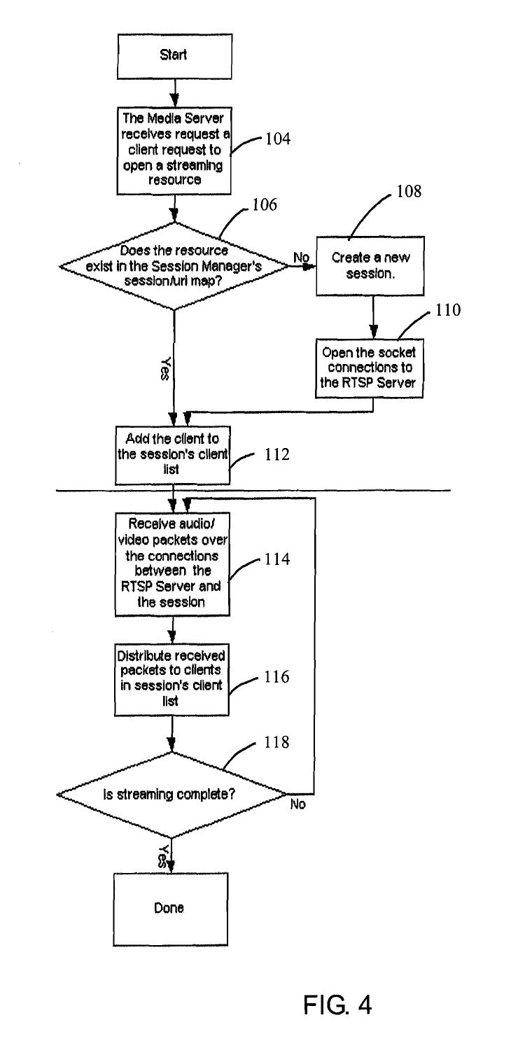

FIG. 4 is a schematic representation of a process 100 of streaming media in accordance with an embodiment of the present invention. In operation 104, a client request to open a streaming resource may be received by an intermediary device, such as the intermediary server 14 of FIG. 1. In operation 106, a determination may be made regarding whether the requested streaming resource is already streaming over a single logical connection to the intermediary device from a resource provider, such as the resource server 12 of FIGS. 1-3. A session manager, such as the session manager 40 of FIGS. 2 and 3, may track streaming resources by establishing a session for each streaming resource.

If, during operation 106, it is determined that the requested streaming resource is not already streaming over a single logical connection to the intermediary device, a new session may be created (operation 108) and a single logical connection may be established between the intermediary device and the resource provider (operation 110). In an embodiment, the single logical connection includes a set of socket connections to the resource provider. In operation 112, the client requesting the steaming resource may be associated with the session for the streaming resource streaming over the logical connection between the intermediary device and the resource provider. If during operation 106, it is determined that the requested streaming resource is streaming over a single logical connection to the intermediary device, the client requesting the streaming resource may be associated (operation 112) with the session for the streaming resource. Whenever a new client requests the streaming resource that is being received from the resource provider over the single logical connection, operations 104,106, and 112 may be repeated so as to associate new clients with the session for the streaming resource.

In operation 114, the streaming resource is received from the resource provider over the single logical connection. The streaming resource received over the single logical connection may be distributed (operation 116) to the client or clients that is/are associated with the session for the requested streaming resource. In an embodiment, the streaming resource received over the single logical connection may be received in packets.

In operation 118, a determination may be made regarding whether streaming of the streaming resource is complete. If, during operation 118, it is determined that streaming of the streaming resource is not compete, the receiving and distributing operations (operations 114 and 116) may continue. After it is determined that streaming of the streaming resource is complete, the process 100 terminates.

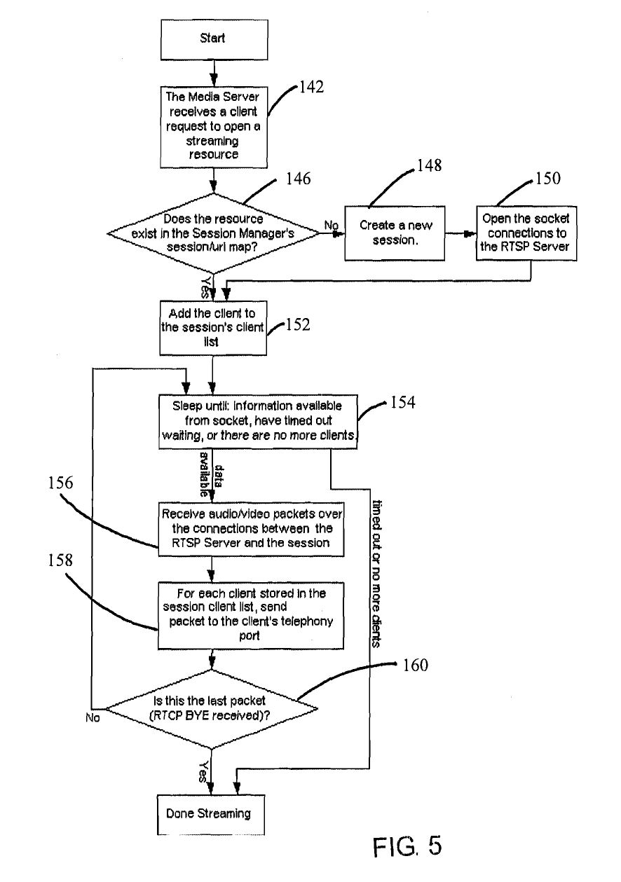

FIG. 5 is a schematic representation of a process 140 of streaming media in accordance with an embodiment of the present invention.

Operations 142 through 152 are similar to operations 104 through 112 of FIG. 4, respectively. Accordingly, a repetitive discussion of these operations is omitted in the interest of brevity.

In operation 154, a period of waiting may result until the occurrence of: the receipt of additional streaming resource information; the passage of a predetermined period of time without receiving any additional streaming resource information (a timeout); or, the loss of all clients associated with the session. If, during operation 154, it is determined that a passage of a predetermined period of time without any activity (a timeout) occurs, or that there are no longer any more clients associated with the session, streaming of the streaming resource terminates. A session manager may make the determination that there are no longer any more clients associated with the session by examining a client list associated with the session. A client may indicate that it is no longer interested in the streaming resource by hanging up, or by switching to a different application. In an embodiment, A PFP may inform an RTSP SAP that a client is no longer interested. The session manager may then remove the client from the list of clients associated with the session.

In an embodiment, operation 154 may be accomplished using multiple processing threads. A first thread may be associated with a session and may gather information from a socket. This first thread may enter a period of waiting (or blocking) for an event. A second thread may inform a session manager that no more clients remain associated with the session. If this occurs, the session manager (using the second thread) may inform the session to shut down and terminate current session handling. This may end the waiting (or blocking) of the first thread. The session may then detect that the end of the waiting (or blocking) was due to a session shutdown.

If during operation 154, it is determined that additional streaming resource information has been received, the streaming resource may be received (operation 156) over the single logical connection from the resource provider. The streaming resource may then be distributed (operation 158) to each client associated with the session. In an embodiment, the streaming resource may be received in packets, and those packets may be forwarded, copied and written into each client's corresponding telephony port.

In operation 160, a determination may be made regarding whether streaming of the streaming resource is complete. If, during operation 160, it is determined that streaming is not complete, the waiting, receiving and distributing operations (operations 154,156 and 160) may be repeated. In an embodiment, a determination that streaming is complete may be made upon receiving an RTCP BYE packet. If, during operation 160, it is determined that streaming is complete, streaming of the streaming resource terminates.

When a client hangs up or otherwise stops receiving a streaming resource, that particular client may be removed from the session for that streaming resource. If no more clients are associated with the session for a streaming resource, that particular session may terminate.

In addition to the components of the various embodiments, the system also may include permanent or removable storage, such as magnetic and optical discs, RAM, ROM, etc. on which the processes and data structures of the present invention can be stored and distributed. The processes may also be distributed via, for example, downloading over a network such as the Internet.

The above exemplary embodiments enable distribution of media received from a media server over a single logical connection to multiple clients.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A process, comprising:
setting up a single logical connection to a media server for a media to be transmitted; and
transmitting the media from the media server over the single logical connection to a plurality of clients.

2. The process of claim 1, wherein the transmitting of the media from the media server over the single logical connection to the plurality of clients comprises duplicating the media for the plurality of clients.

3. The process of claim 1, wherein the setting up a single logical connection to a media server for a media to be transmitted comprises establishing a streaming session for the single logical connection, and wherein the plurality of clients are associated with the streaming session.

4. The process of claim 1, wherein the setting up a single logical connection to a media server for a media to be transmitted comprises opening socket connections to a Real Time Streaming Protocol (RTSP) server.

5. The process of claim 1, wherein the transmitting of the media from the media server over the single logical connection to the plurality of clients comprises transmitting the media from the media server over the single logical connection to a plurality of mobile telephones.

6. A process, comprising:
establishing a streaming session for a streaming resource by opening a single set of socket connections to a media server; and
providing the streaming resource received via the single set of socket connections to a plurality of mobile telephones.

7. The process of claim 6, wherein the establishing of a streaming session for the streaming resource by opening the single set of socket connections to the media server comprises establishing the streaming session for the streaming resource by opening the single set of socket connections to a Real Time Streaming Protocol (RTSP) server.

8. The process of claim 6, wherein the providing of the streaming resource received via the single set of socket connections to the plurality of mobile telephones comprises duplicating the streaming resource received via the single set of socket connections.

9. A process, comprising:
tracking a plurality of users requesting a data resource stored on a server;
receiving the data resource over a single logical connection to the server; and
duplicating the received data resource for the plurality of users requesting the data resource stored on the server.

10. The process of claim 9, wherein the receiving of the data resource over a single logical connection to the server comprises opening socket connections to the server.

11. The process of claim 9, wherein the receiving of the data resource over the single logical connection to the server comprises receiving data packets and wherein the duplicating of the received data resource for the plurality of users requesting the data resource stored on the server comprises duplicating the received data packets.

12. An apparatus, comprising:
a receiver to receive packets over a single set of socket connections for a streaming resource; and
a provider to provide the packets received over the single set of socket connections to a plurality of mobile telephones.

13. The apparatus of claim 12, further comprising:
a duplicator to duplicate the packets received over the single set of socket connections.

14. A system, comprising:
a media server including a streaming resource;
a plurality of mobile phones; and
a unit to establish a streaming session for the streaming resource by opening a single set of socket connections to the media server and to provide the streaming resource received via the single set of socket connections to the plurality of mobile phones.

15. The system of claim 14, wherein the media server including the streaming resource comprises:
a Real Time Streaming Protocol (RTSP) server.

16. The system of claim 14, wherein the unit to establish the streaming session for the streaming resource by opening the single set of socket connections to the media server and to provide the streaming resource received via the single set of socket connections to the plurality of mobile phones comprises:
a streaming resource duplicator.

17. A system, comprising:
a server including a data resource;
a unit to track a plurality of users requesting the data resource;
a receiver to receive the data resource over a single logical connection to the server; and
a duplicator to duplicate the received data resource for the plurality of users requesting the data resource stored on the server.

18. The system of claim 17, wherein the receiver to receive the data resource comprises a data packet receiver to receive data packets, and the duplicator to duplicate the received data resource for the plurality of users requesting the data resource stored on the server duplicates the received data packets.

19. A system, comprising
a means for establishing a single logical connection to a server for a media to be transmitted; and
a means for transmitting the media from the media server over the single logical connection to a plurality of clients.

20. A storage comprising a data structure, the data structure comprising:
a field comprising a media identifier
a field comprising a session identifier associated with the media identifier; and
a field comprising a client identifier associated with the session identifier.

21. A method, comprising:
receiving a request from a client for a streaming resource;
checking to see if a session for the streaming resource exists and if not, starting the session for the streaming resource by opening a single set of socket connections to a media server including the streaming resource;
associating the client with the session;
awaiting streaming resource data;
copying the streaming resource data for each client associated with the session;
writing copied streaming resource data into a buffer for at least one socket for each client associated with the session;
determining whether one of a last packet of the streaming resource data has been received, a timeout has occurred, or a last client is no longer associated with the session, has occurred and if so, terminating the method; and
repeating the awaiting, copying, and determining operations.
